(19) United States
(12) Patent Application Publication
(10) Pub. No.: US 2014/0018942 A1
(43) Pub. Date: Jan. 16, 2014

(54) DISPLAY APPARATUS AND METHODS TO DISPLAY ENERGY OUTPUT

(71) Applicants: Robert Paul Stachow, Carson City, NV (US); Brandon James Rank, Minden, NV (US); Trevor Shaun Kavanaugh, Minden, NV (US)

(72) Inventors: Robert Paul Stachow, Carson City, NV (US); Brandon James Rank, Minden, NV (US); Trevor Shaun Kavanaugh, Minden, NV (US)

(21) Appl. No.: 13/545,862

(22) Filed: Jul. 10, 2012

(51) Int. Cl. G05B 15/00

(52) U.S. Cl. 700/83

(57) ABSTRACT

A display apparatus is provided. The display apparatus includes a circuit coupled to at least one energy harvester, wherein the circuit is configured to receive at least one signal that is representative of a detected energy output from the energy harvester. The circuit is also configured to generate at least one output representative of a quantification of the detected energy output. A display interface is coupled to the circuit and is configured to display the output generated by the circuit.

### BACKGROUND OF THE INVENTION

The field of the invention relates generally to energy harvesting survey systems and, more particularly, to a display apparatus for use with energy harvesting survey systems.

At least some known machines, such as auxiliary assets that are used in power generation or refining applications, such as electric motors and motor-driven pumps may generate excess or waste heat. For example, machines, such as steam turbines or gas turbines may generate excess or waste heat that does not have an immediate use in, for example, the power generation process. As a result, the machines may be part of, or combined with, energy harvesting systems that attempt to capture the waste heat such that thermal energy from the waste heat may be available for use, such as, for example, power generation.

At least some known energy harvesting systems may include, for example, thermoelectric generators that are configured to capture thermal energy. At least some known thermoelectric generators include a junction of two dissimilar materials, such as two dissimilar conductors. A thermal gradient formed between the two conductors produces a voltage. Large power outputs are generated by electrically connecting many junctions together in series and by connecting many junctions thermally in parallel. As a result, the machines may be part of, or combined with, energy harvesting systems that attempt to capture the waste heat and/or vibrational energy.

Energy harvesting systems depend on the available waste heat and/or vibrational energy being produced by a machine. For example, a vibration energy harvester survey tool with a built-in display may be used to identify the available waste energy of a machine. However, the display is powered by harvested energy and it is usable primarily for survey purposes. A digital multimeter (DMM) may be connected to an energy harvester. This device includes the energy harvester as well as a DMM connected to the harvester output. However, the DMM does not provide actual power output (either current or voltage). Moreover, without the use of additional circuitry, the DMM does not provide a measure of power output as a function of load. Accordingly, a user may be unable to indicate to an installer of energy harvesters if the current position of the energy harvester results in sufficient energy output.

### BRIEF DESCRIPTION OF THE INVENTION

In one embodiment, a display apparatus is provided. The display apparatus includes a circuit coupled to at least one energy harvester, wherein the circuit is configured to receive at least one signal that is representative of an energy output from the energy harvester. The circuit is also configured to generate at least one output representative of a quantification of the energy output. A display interface is coupled to the circuit and is configured to display the output generated by the circuit.

In another embodiment, an energy harvesting survey system is provided. The energy harvesting survey system includes an energy source and at least one energy harvester coupled to the energy source, wherein the energy harvester is configured to generate an energy output. A display apparatus is coupled to the energy harvester and includes a circuit that is configured to receive at least one signal representative of the energy output from the energy harvester. The circuit is also configured to generate at least one output representative of a quantification of the energy output. The display apparatus also includes a display interface that is coupled to the circuit and is configured to display the output generated by the circuit.

In yet another embodiment, a method for displaying an energy output is provided. At least one signal is received, via a circuit, and the signal is representative of an energy output from at least one energy harvester. At least one output representative of a quantification of the energy output is generated by the circuit. The output is displayed via a display interface.

### BRIEF DESCRIPTION OF THE DRAWINGS

FIG. 1 is a block diagram of an exemplary energy harvesting survey system; and

FIG. 2 is a block diagram of an exemplary display apparatus that may be used with the energy harvesting survey system shown in FIG. 1 and taken along area 2.

### DESCRIPTION OF THE INVENTION

The exemplary apparatus, systems, and methods described herein overcome at least some disadvantages associated with known energy harvesting survey systems by providing an apparatus that efficiently and substantially instantaneously displays, in real-time, a quantification of an energy output being produced by a machine. In particular, the embodiments described herein provide a display apparatus that is removably coupled to at least one energy harvester that generates an energy output based on waste energy received from an energy source. The display apparatus also includes a circuit that generates at least one output representative of a quantification of the energy output. A display interface is coupled to the circuit to enable the output generated by the circuit to be displayed to a user to enable the user to identify the actual energy output being produced by the energy harvester. As such, a user is able to readily indicate to an energy harvester installer if the current position of the energy harvester results in sufficient energy output and/or the user may be able to readily conduct an energy harvester output survey of the energy source.

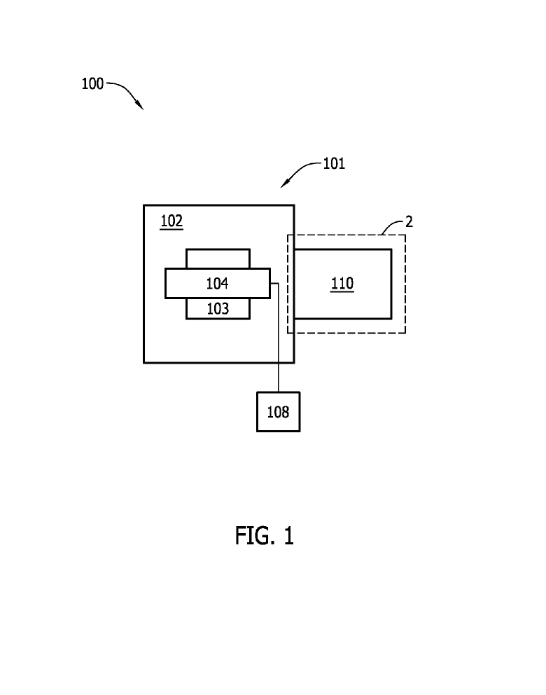

FIG. 1 illustrates an energy harvesting survey system 100 that includes a power generation system 101. While the exemplary embodiment includes a power generation system 101, it should be noted that the current disclosure is not limited to power generation systems. Energy harvesting survey system 100 may include any type of system that produces energy, such as waste heat, and one of ordinary skill in the art will appreciate that the current disclosure may be used with any type of system.

In the exemplary embodiment, power generation system 101 includes an energy source, such as a machine 102, which is a gas turbine. Machine 102 may also be any other type of variable speed machine that generates power and produces excess or waste heat and/or vibrational energy, such as a hydroelectric steam turbine. Alternatively, machine 102 may be a synchronous speed machine that generates power and produces excess or waste heat and/or vibrational energy. While the exemplary power generation system 101 includes one machine 102 that is a gas turbine, it should be noted that power generation system 101 may include any number of machines and/or combinations of different types of machines. For example, power generation system 101 may be a combined-cycle power generation system that includes at least one gas turbine and at least one steam turbine.

Machine 102 includes at least one component, such as a rotor 103 and a drive shaft 104. Moreover, in the exemplary embodiment, drive shaft 104 is coupled to a load 108, such as a generator, and rotor 103 is configured to rotate drive shaft 104. It should be noted that, as used herein, the term “couple” is not limited to a direct communicative, mechanical, and/or an electrical connection between components, but may also include an indirect communicative, mechanical, and/or electrical connection between multiple components. In the exemplary embodiment, drive shaft 104 is at least partially supported by one or more bearings (not shown) housed within machine 102 and/or within load 108. Alternatively or additionally, the bearings may be housed within a separate support structure (not shown), such as a gearbox, or any other structure that enables machine 102 and/or energy harvesting survey system 100 to function as described herein.

Energy harvesting survey system 100, in the exemplary embodiment, also includes an energy harvester (not shown) coupled to machine 102. In the exemplary embodiment, the energy harvester is an energy harvesting device that is configured to generate an energy output from waste energy received from machine 102. For example, the energy harvester may be configured to convert thermal energy and/or vibrational energy that is produced by machine 102 to electrical energy. A display apparatus 110 is coupled to the energy harvester and, as explained in more detail below, display apparatus 110 is configured to generate at least one output representative of a quantification of the energy output being produced by the energy harvester in real time. Display apparatus 110 is also configured to display the output to a user.

During operation, machine 102 generates mechanical rotational energy via rotor 103 and drives generator 108. Generator 108 then supplies electrical power to, for example, a power distribution system (not shown). Moreover, in the exemplary embodiment, as rotational energy is generated via rotor 103, machine 102 also produces an energy output, such as waste heat and/or vibrational energy. The energy harvester converts the waste energy being produced by machine 102 and transmits a signal representative of the energy harvester output to display apparatus 110. As explained in more detail below, display apparatus 110 then generates at least one output representative of a quantification of the energy output. Display apparatus 110 also displays the output to a user. As such, display apparatus 110 is enabled to efficiently and substantially instantaneously display the actual energy being produced by the energy harvester. Accordingly, a user is able to readily indicate to an energy harvester installer if the current position of the energy harvester results in sufficient energy output and/or the user may be able to readily conduct an energy harvester output survey of machine 102.

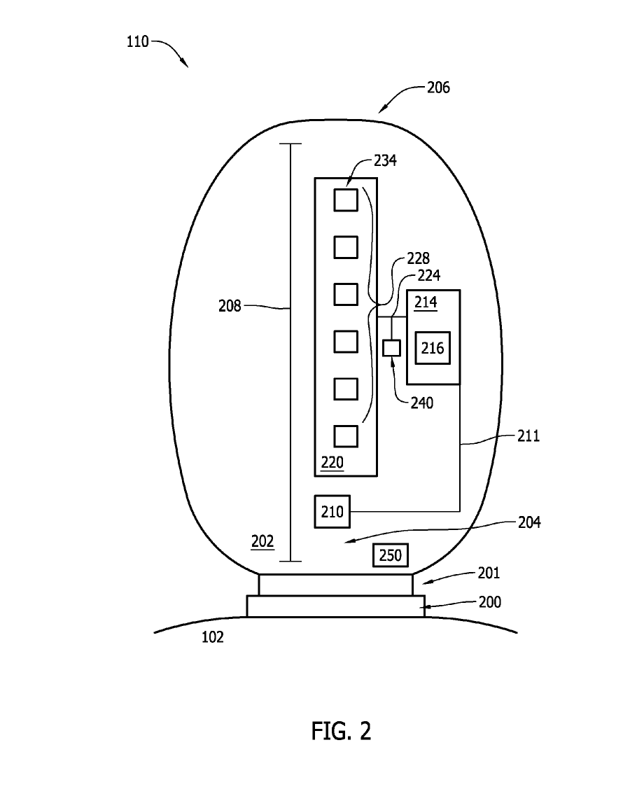

FIG. 2 illustrates display apparatus 110 coupled to an energy harvester (not shown) and taken along area 2 (shown in FIG. 1). More specifically, in the exemplary embodiment, machine 102 includes an output 200 that is coupled to an output connector 201. The energy harvester is coupled to output connector 201, and the energy harvester is coupled to display apparatus 110. Moreover, in the exemplary embodiment, the energy harvester is configured to convert waste energy being produced by machine 102. For example, the energy harvester may be configured to convert thermal energy being lost from machine output 200 to electrical energy. The energy harvester may also convert vibrations being produced by machine 102 to electrical energy. Alternatively, the energy harvester may convert any other forms of waste energy being produced by machine 102 that enables display apparatus 110 and/or energy harvesting survey system 100 to function as described herein. In the exemplary embodiment, the energy harvester is also configured to generate at least one signal representative of the energy output generated by the energy harvester.

In the exemplary embodiment, display apparatus 110 includes a main body 202 that includes a first end 204 positioned proximate to machine 102, wherein first end 204 is coupled to output connector 201. Main body 202 also includes a second end 206 positioned a predefined distance 208 from first end 204. Display apparatus 110, in the exemplary embodiment, also includes a circuit 214 that is coupled to the energy harvester via conduit 211. In the exemplary embodiment, circuit 214 includes any suitable analog and/or digital circuit and/or circuit components. For example, circuit 214 may include any suitable processor-based or microprocessor-based system, such as a computer system, that includes microcontrollers, reduced instruction set circuits (RISC), application-specific integrated circuits (ASIC), programmable logic controllers (PLC), logic circuits, and/or any other circuit or processor that is capable of executing the functions described herein. In one embodiment, circuit 214 may include a processor 216 having a single processing unit or having multiple processing units (e.g., in a multi-core configuration). The above examples are exemplary only, and thus are not intended to limit in any way the definition and/or meaning of the term “circuit.”

In the exemplary embodiment, circuit 214 is configured to receive the energy output from the energy harvester and circuit 214 is configured to generate at least one output representative of a quantification of the energy output. The output generated by circuit 214 may be a visual and/or audio output. To generate an output of an amount of energy being produced by the energy harvester, circuit 214 may be configured to calculate the amount of energy by any suitable methods known in the art. For example, processor 216 may be programmed with various algorithms known in the art to determine the expected amount of energy to be produced by the energy harvester based on for example, expected load devices to be powered by the energy harvester.

Moreover, in the exemplary embodiment, display apparatus 110 includes a display interface 220 that is coupled to circuit 214 via a conduit 224. Display interface 220 is configured to display the output(s) generated by circuit 214 to a user. More specifically, in the exemplary embodiment, display interface 220 is a visual display device, such as a cathode ray tube (CRT), a liquid crystal display (LCD), an light emitting diode (LED) display, an organic LED display, and/or an “electronic ink” display. For example, display interface 220 may include at least one LED 228, wherein LED 228 is activated when, for example, the output generated by circuit 214 represents that the amount of energy being produced by the energy harvester exceeds a predefined threshold value. Accordingly, LED 228 may emit a light to a user when the predefined threshold value for an amount of energy has been reached and/or exceeded. Display interface 220 may also include a plurality of LEDs 228 to indicate a gradient of different levels of the calculated amounts of energy. For example, a first LED 230 may represent the lowest amount of energy being produced by the energy harvester. A fifth or last LED 234 may represent the highest amount of energy being produced by the energy harvester. Display interface 220 may also display the output generated by circuit 214 in any other manner that enables display apparatus 110 and/or energy harvesting survey system 100 to function as described herein. For example, display device 220 may present the actual calculated energy being produced by the energy harvester.

In the exemplary embodiment, display apparatus 110 may also include an audio output device 240 coupled to circuit 214 via conduit 224. In the exemplary embodiment, audio output device 240 is an audio adapter and/or a speaker. Alternatively, audio output device 240 may be any type of device that enables display apparatus 110 and/or energy harvesting survey system 100 to function as described herein. In the exemplary embodiment, audio output device 240 is configured to receive an output from circuit 214 and to generate an audio signal based on the output received. Audio output device 240 is configured to transmit the audio signal to the user. In the exemplary embodiment, the audio signal may be an audio alarm that may annunciate an actual calculated amount of energy being produced by the energy harvester. Alternatively, audio signal may be any type of audio signal that enables display apparatus 110 and/or energy harvesting survey system 100 to function as described herein.

Moreover, in the exemplary embodiment, display apparatus 110 may include a power supply 250 that is coupled within main body 202 and is configured to provide electrical energy to display apparatus 110. In the exemplary embodiment, power supply 250 is a battery, such as a rechargeable lithium ion battery. Alternatively, power supply 250 may be any type of device configured to supply electrical energy within display apparatus 110.

During operation, as rotational energy is generated via rotor 103 (shown in FIG. 1), machine 102 produces an energy output, such as vibrations and/or waste heat. In the exemplary embodiment, the energy harvester converts the waste energy output being produced by machine 102 to electrical energy and transmits at least one signal representative of the output to display apparatus 110. Display apparatus 110 then displays a quantification of the energy output being produced by the energy harvester in real time. More specifically, the energy harvester generates a signal representative of the energy output and transmits the signal to display apparatus. Circuit 214 then generates at least one output representative of the actual energy being produced by the energy harvester. For example, circuit 214 may then generate a visual and/or an audio output of the actual amount of energy being produced by the energy harvester.

The output(s) generated by circuit 214 are then transmitted to display apparatus 220 such that the output(s) may be presented to a user. For example, LED 228 may be activated and emit a light to the user when the predefined threshold value for an amount of energy has been reached and/or exceeded. Display apparatus 220 may also display an indication of a gradient of different levels of amounts of energy. For example, first LED 230 may be activated when the output generated by circuit 214 represents that the energy harvester is outputting the lowest amount of energy.

Circuit 214 may also transmit an audio output to audio output device 240. Audio output device 240 generates an audio signal based on the output received. For example, audio output device 240 may generate an audio signal based on the actual amount of energy that the energy harvester is producing. Audio output device 240 then transmits the audio signal to the user.

As compared to known apparatus, systems, and methods that are used to display and/or to quantify energy, the embodiments described herein provide a display apparatus efficiently and substantially instantaneously displays a quantification of an energy output being produced by an energy harvester in real time. In particular, the embodiments described herein provide a display apparatus that is removably coupled to at least one energy harvester that converts waste energy that is being produced by an energy source to electrical energy. The display apparatus includes a circuit that is configured to receive at least one signal that is representative of the energy output. The circuit is also configured to generate at least one output representative of a quantification of the energy output. A display interface is coupled to the circuit and is configured to display the output generated by the circuit. Accordingly, a user is able to readily indicate to an energy harvester installer if the current position of the energy harvester sufficient energy output and/or the user may be able to readily conduct an energy harvester output survey of the machine.

A technical effect of the apparatus, systems, and methods described herein includes at least one of: (a) receiving, via a circuit, at least one signal that is representative of an energy output from at least one energy harvester; (b) generating, via a circuit, at least one output representative of a quantification of an energy output; and (c) displaying at least one output via a display interface.

Exemplary embodiments of the apparatus, systems, and methods are described above in detail. The apparatus, systems, and methods are not limited to the specific embodiments described herein, but rather, components of the apparatus, systems, and/or steps of the methods may be utilized independently and separately from other components and/or steps described herein. For example, the system may also be used in combination with other apparatus, systems, and methods, and is not limited to practice with only the system as described herein. Rather, the exemplary embodiment can be implemented and utilized in connection with many other applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A display apparatus comprising:
a circuit coupled to at least one energy harvester, wherein said circuit is configured to receive at least one signal that is representative of an energy output generated from the at least one energy harvester and to generate at least one output representative of a quantification of the energy output; and
a display interface coupled to said circuit, wherein said display interface is configured to display the at least one output generated by said circuit.

2. A display apparatus in accordance with claim 1, wherein said circuit is configured to receive the at least one signal that is representative of the energy output that is generated based on a vibrational energy input.

3. A display apparatus in accordance with claim 1, wherein said circuit is configured to receive the at least one signal that is representative of the energy output that is generated based on a thermal energy input.

4. A display apparatus in accordance with claim 1, further comprising an audio output device coupled to said circuit, wherein said audio output device is configured to generate an audio signal based on the at least one output generated by said circuit, said audio output device is configured to transmit the audio signal to the user.

5. A display apparatus in accordance with claim 1, further comprising a power supply coupled within said main body.

6. A display apparatus in accordance with claim 1, wherein said display interface comprises at least one light-emitting diode.

7. A display apparatus in accordance with claim 6, wherein said at least one light emitting diode comprises a plurality of light-emitting diodes that are configured to indicate a gradient of a plurality of levels of the quantified energy output.

8. An energy harvesting survey system comprising:
an energy source;
at least one energy harvester coupled to said energy source, said at least one energy harvester configured to generate an energy output; and
a display apparatus coupled to said at least one energy harvester, said display apparatus comprising:
a circuit configured to receive at least one signal representative of the energy output from said at least one energy harvester and to generate at least one output representative of a quantification of the energy output; and
a display interface coupled to said circuit, wherein said display interface is configured to display the at least one output generated by said circuit.

9. An energy harvesting survey system in accordance with claim 8, wherein said at least one energy harvester is configured to generate the energy output from a vibrational energy input.

10. An energy harvesting survey system in accordance with claim 8, wherein said at least one energy harvester is configured to generate the energy output from a thermal energy input.

11. An energy harvesting survey system in accordance with claim 8, wherein said display apparatus further comprises an audio output device coupled to said circuit, wherein said audio output device is configured to generate an audio signal based on the at least one output generated by said circuit, said audio output device is configured to transmit the audio signal to the user.

12. An energy harvesting survey system in accordance with claim 8, further comprising a power supply coupled within said main body.

13. An energy harvesting survey system in accordance with claim 8, wherein said display interface comprises at least one light-emitting diode.

14. An energy harvesting survey system in accordance with claim 13, wherein said at least one light emitting diode comprises a plurality of light-emitting diodes that are configured to indicate a gradient of a plurality of levels of the quantified energy output.

15. A method for displaying an energy output, said method comprising:
receiving, via a circuit, at least one signal that is representative of an energy output from at least one energy harvester;
generating, via the circuit, at least one output representative of a quantification of the energy output; and
displaying the at least one output via a display interface.

16. A method in accordance with claim 15, wherein receiving, via a circuit, at least one signal further comprises receiving, via a circuit, at least one signal that is representative of an energy output that is generated based on a vibrational energy input.

17. A method in accordance with claim 15, wherein receiving, via a circuit, at least one signal further comprises receiving, via a circuit, at least one signal that is representative of an energy output that is generated based on a thermal energy input.

18. A method in accordance with claim 15, further comprising receiving, via the at least one energy harvester, waste energy from an energy source.

19. A method in accordance with claim 15, wherein displaying the at least one output further comprises displaying the at least one output via at least one light-emitting diode.

20. A method in accordance with claim 15, wherein displaying the at least one output further comprises displaying the at least one output via a plurality of light-emitting diodes that are configured to indicate a gradient of a plurality of levels of the quantified energy output.
